(19) United States
(12) Patent Application Publication
(10) Pub. No.: US 2007/0295885 A1
(43) Pub. Date: Dec. 27, 2007

(54) Tool Hanging Bracket

(76) Inventor: Anthony Vidal, Tucson, AZ (US)

Correspondence Address: QUICKPATENTS, INC., 32861 CALLE PERFECTO, SUITE A, SAN JUAN CAPISTRANO, CA, 92675, US

(21) Appl. No.: 11/557,469

(22) Filed: Nov. 7, 2006

Related U.S. Application Data
(60) Provisional application No. 60/812,505, filed on Jun. 12, 2006.

(51) Int. Cl. F16M 11/00

(52) U.S. Cl. 248/682

(57) ABSTRACT

A tool hanging bracket for suspending a tool from an object is disclosed. The tool is of the type having a rear end that includes a plurality of mounting screws thereon, such as a nail gun. The bracket comprises a tool engaging plate that has a plurality of apertures aligned with the mounting screws of the tool. An upward extension section is attached at one end of the tool engaging plate at one end thereof, and a forward extension section is attached at one end to, and extends angularly away from, a second end of the extension section. A hook section is attached at one end to, and extends angularly away from, a second end of the forward extension section. In use, with the tool engaging plate attached to the rear end of the tool with the mounting screws, the upward extension section, forward extension section, and hook section project upward and forward from the rear end of the tool. As such, the hook section may be engaged with the object to suspend the tool therefrom. The bracket projects forward above the top of the tool, and the hook section is located far enough forward of the rear end of the tool such that the center of gravity of the tool is located horizontally between the tool engaging plate and the hook section, such that the tool is balanced when suspended from the object.

### CROSS-REFERENCE TO RELATED APPLICATIONS

This application claims the benefit of U.S. Provisional Application No. 60/812,505 filed on Jun. 12, 2006.

### STATEMENT REGARDING FEDERALLY SPONSORED RESEARCH AND DEVELOPMENT

Not Applicable.

### FIELD OF THE INVENTION

This invention relates to tools, and more particularly to a novel tool hanging bracket.

### DISCUSSION OF RELATED ART

The relatively recent advent of high-quality nail guns and similar tools in the construction industry has greatly improved efficiency of construction workers, and particularly wood framers. However, as is the case with many advances, new problems and inconveniences arise as a result. For example, nail guns are typically someone heavy and bulky, and often either have a compressed air hose or electric cord connected thereto. This makes them difficult to balance on a ladder or beam without the nail gun falling. Clearly such an event can not only damage the nail gun, but can also injure other workers on the job site.

Tool belts have long been worn by construction workers to provide a convenient place to store nails, screws, tools, and other supplies that are helpful to have at the ready. However, nail guns are typically too heavy to clip onto a tool belt, and tool guns typically have no means of clipping onto a belt in the first place. As such, tool belts are not a practical solution to the problem of temporarily supporting a nail gun when the nail gun is not needed or in use.

Other tool holders and hooks have been invented for conveniently and temporarily supporting a tool on the job site. For example, U.S. Pat. No. 5,901,998 to Gallo, Jr. teaches a tool and parts carrier for attachment to the top of a ladder. Such a device is well-suited for holding smaller items such as small tools, nails, screws and the like. However, a typical heavy-duty nail gun will not fit well in such a device, nor will it be stably supported thereby. Anyone tripping on the nail gun air hose or power cord may cause a nail gun supported by such a device to flip-out of the tray, potentially harming someone or damaging property.

Other two-part holders, such as that taught in U.S. Pat. No. 5,913,500 to Estes on Jun. 22, 1999, teach a hook portion for mounting on a support structure, and a hook portion for attaching to the tool. On a construction job site, however, it is not practical to mount a hook on the various structures to which you might wish to support a nail gun, since the location of such a hook would be constantly changing. Further, mounting such a hook support to different structures on a construction project may undesirably damage the structure that is being built.

U.S. Pat. No. 5,988,828 to Prince et al. teaches a device for supporting a flashlight, or the like, with a hook member. While such a device may be well-suited for a relatively light object such as a flashlight, nail guns tend to be quite heavy and, as such, a much more robust and durably hook would need to be used. Further, such a hook is not convenient to use for holding an object onto a standard 2×4 wooden beam and similar readily-available objects that are found at a typical construction job site.

As such, there is clearly a need for a strong and durable support device for temporarily yet securely holding a nail gun to any suitable nearby object at a construction site, such as ladders, wooden beams, and the like. Such a needed device would be attachable to existing nail guns, and would be relatively simple and inexpensive to make. The present invention accomplishes these objectives.

### SUMMARY OF THE INVENTION

The present device is a tool hanging bracket for suspending a tool from an object, such as a ladder, a wooden beam or like object. The tool is of the type having a rear end that includes a plurality of mounting screws thereon, such as a nail gun. The bracket comprises a tool engaging plate that has a plurality of apertures aligned with the mounting screws of the tool.

An upward extension section is attached at one end of the tool engaging plate at one end thereof, preferably from a peripheral edge of the plate. A forward extension section is attached at one end to, and extends angularly away from, a second end of the extension section. Preferably the forward extension section extends away from the second end of the extension section at an angle of between 60 and 90 degrees, but ideally about 60 degrees.

A hook section is attached at one end to, and extends angularly away from, a second end of the forward extension section. Preferably the hook section extends away from the second end of the forward extension section at an angle of between 30 and 90 degrees, but ideally about 45 degrees.

In use, with the tool engaging plate attached to the rear end of the tool with the mounting screws, the upward extension section, forward extension section, and hook section project upward and forward from the rear end of the tool. As such, the hook section may be engaged with the object to suspend the tool therefrom. The bracket is conveniently located above the top of the tool, and the hook section is located far enough forward of the rear end of the tool such that the center of gravity of the tool is located horizontally between the tool engaging plate and the hook section, such that the tool is balanced when suspended from the object.

The present invention is a strong and durable support device for temporarily yet securely holding a nail gun or similar tool to any suitable nearby object at a construction site, such as ladders, wooden beams, and the like. The present device is attachable to existing nail guns, and is relatively simple and inexpensive to make. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is perspective view of the invention, illustrating a bracket of the invention as mounted on a tool and the tool and bracket as suspended from an object;

FIG. 2 is a perspective view of the bracket of the invention; and

FIG. 3 is an exploded view of the invention, illustrating mounting screws and a mechanism projection of the tool and corresponding apertures in a tool engaging plate of the bracket of the invention.

### DETAILED DESCRIPTION OF THE PREFERRED EMBODIMENT

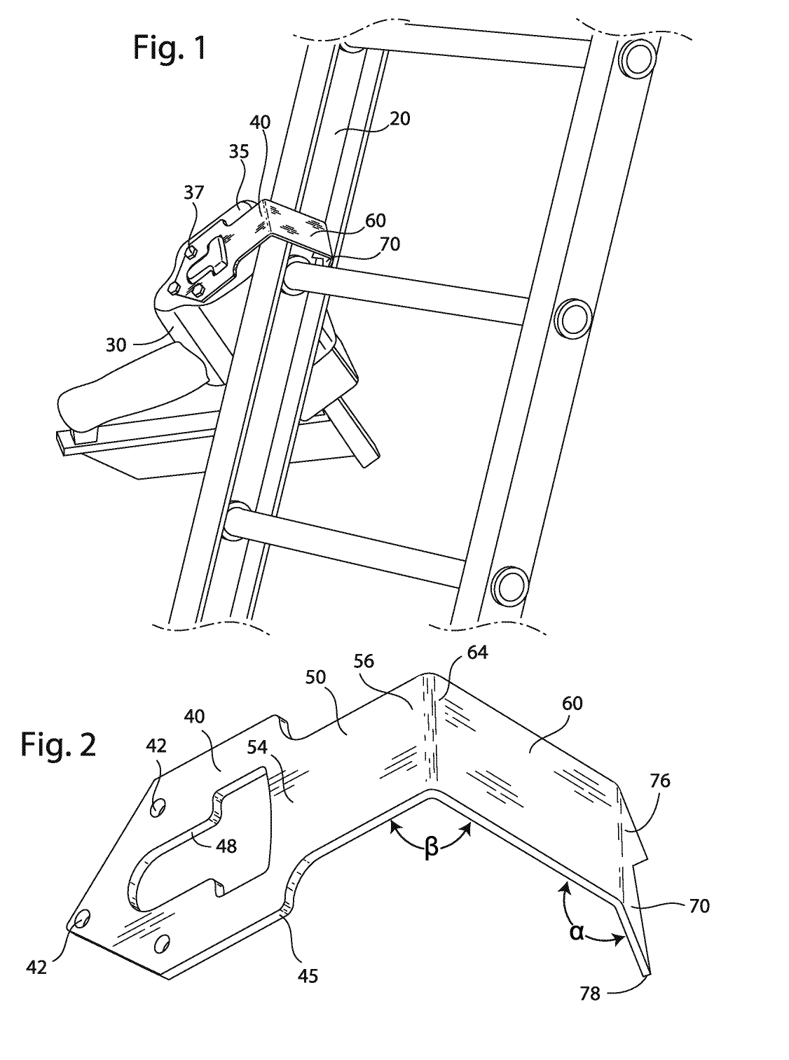

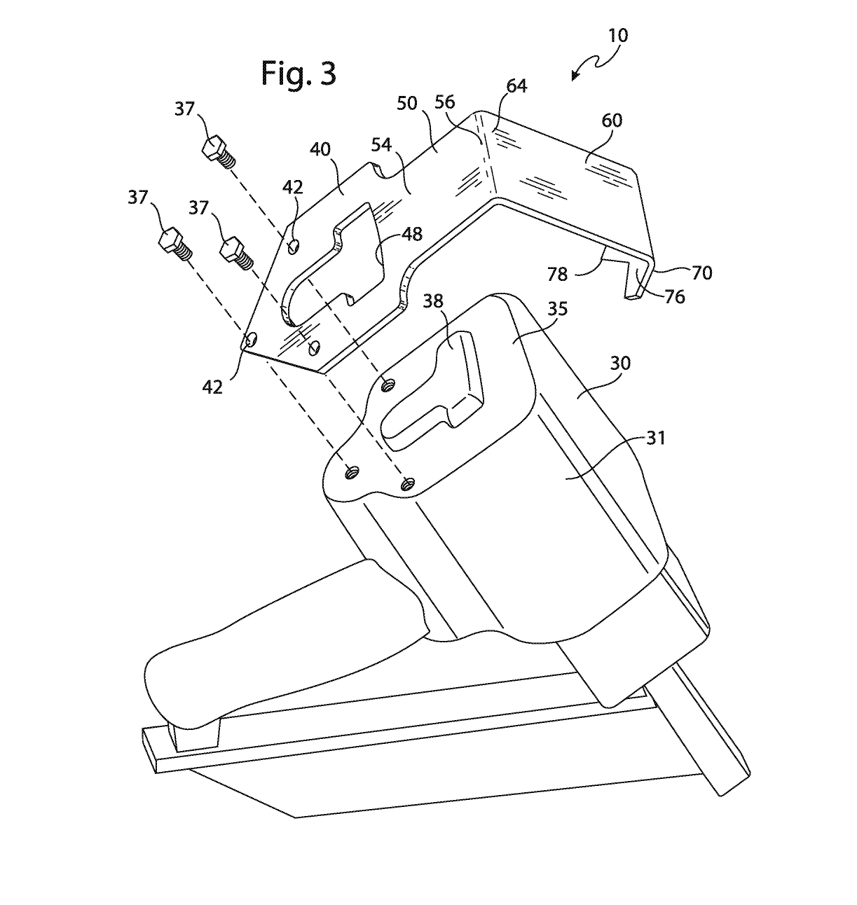

FIG. 1 illustrates a tool hanging bracket 10 for suspending a tool 30 from an object 20, such as a ladder, a wooden beam or like object. The tool 30 is of the type having a rear end 35 that includes a plurality of mounting screws 37 thereon, such as a nail gun 31 (FIG. 3).

The tool hanging bracket 10 comprises a tool engaging plate 40 that has a plurality of apertures 42 aligned with the mounting screws 37 of the tool 30. As such, the tool engaging plate 40 of the bracket 10 may be fixed to the rear end 35 of the tool 30 with the mounting screws 37.

In the case where the tool 30 includes a mechanism projection 38 at the rear end 35 of the tool 30, the tool engaging plate 40 further includes a cut-out aperture 48 for receiving the mechanism projection 38 (FIG. 3). Clearly the shape of the cut-out aperture 48 may be altered according to the corresponding shape of any projections 38 from any particular tool 30; nail guns 31 often include a generally T-shaped mechanism projection 38 as shown.

An upward extension section 50 is attached at one end 54 of the tool engaging plate 40 at one end 54 thereof, preferably from a peripheral edge 45 of the plate 40. Preferably the upward extension section 50 and the tool engaging plate 40 are made from a rigid metal, such as hardened steel or other suitably strong material, so as to withstand the forces experienced when suspending the entire weight of the tool 30 from the object 20. As such, the bracket 10 can withstand rough handling in a construction environment, such as being dropped from several floors onto a hard cement surface, or like treatment.

A forward extension section 60 is attached at one end 64 to, and extends angularly away from, a second end 56 of the extension section 50 (FIG. 2). Preferably the forward extension section 60 extends away from the second end 56 of the extension section 50 at an angle β of between 60 and 90 degrees, but ideally about 60 degrees.

A hook section 70 is attached at one end 74 to, and extends angularly away from, a second end 66 of the forward extension section 60 (FIG. 2). Preferably the hook section 70 extends away from the second end 66 of the forward extension section 60 at an angle α of between 30 and 90 degrees, but ideally about 45 degrees. Preferably the hook section 70 is split into two points 78 at a second end 76 thereof, such that the points may at least partially bite into the object 20 to further hold the tool 30 to the object 20, particularly in the case where the object is a wooden beam or the like (not shown).

The tool engaging plate 40, upward extension section 50, forward extension section 60, and hook section 70 are all preferably stamped from the same flat sheet of rigid metal material, such as steel. Each section 50, 60, 70 is then preferably bent into the desired shape, the hook section 70 and the forward extension section 60 forming the angle α therebetween, and the forward extension section 60 and the upward extension section 50 forming the angle β therebetween. Alternately, the bracket 10 may be molded as a solid piece using a suitably strong plastic or resin material.

In use, with the tool engaging plate 40 attached to the rear end 35 of the tool 30 with the mounting screws 37, the upward extension section 50, forward extension section 60, and hook section 70 project upward and forward from the rear end 35 of the tool 30. As such, the hook section 70 may be engaged with the object 20 to suspend the tool 30 therefrom. The bracket 10 is conveniently located above the top of the tool, and the hook section 70 is located far enough forward of the rear end 35 of the tool 30 such that the center of gravity of the tool 30 is located horizontally between the tool engaging plate 40 and the hook section 70, such that the tool 30 is balanced when suspended from the object 20.

While a particular form of the invention has been illustrated and described, it will be apparent that various modifications can be made without departing from the spirit and scope of the invention. For example, the exact angles α and β may vary based on the type of tool 30 with which the bracket 10 is used. Further, the exact placement of apertures 42 may vary based on the mounting screw 37 configuration of the tool 30. Accordingly, it is not intended that the invention be limited, except as by the appended claims.

What is claimed is:

1. A tool hanging bracket for suspending from an object a tool of the typing having a rear end having a plurality of mounting screws thereon, the tool hanging bracket comprising:
a tool engaging plate having a plurality of apertures aligned with the mounting screws of the tool;
an upward extension section attached at one end to, and extending outwardly from, the tool engaging plate;
a forward extension section attached at one end to, and extending angularly away from, a second end of the extension section; and
a hook section attached at one end to and extending angularly away from a second end of the forward extension section;
whereby with the tool engaging plate attached to the rear end of the tool with the mounting screws, the upward extension section, forward extension section, and hook section projecting upwardly and forwardly from the rear of the tool, the hook section may engage the object to suspend the tool therefrom.

2. The tool hanging bracket of claim 1 wherein the tool engaging plate further includes a cut-out aperture for receiving a mechanism projection of the tool.

3. The tool hanging bracket of claim 1 wherein the hook section is split into two points at a second end thereof, the points for biting at least partially into the object to further hold the tool to the object.

4. The tool hanging bracket of claim 1 wherein the hook section extends away from the second end of the forward extension section at an angle of between 30 and 90 degrees.

5. The tool hanging bracket of claim 1 wherein the forward extension section extends away from the second end of the extension section at an angle of between 60 and 90 degrees.

6. The tool hanging bracket of claim 3 wherein the two points are adapted for biting at least partially into a standard wooden beam.

7. A nail gun tool comprising:
a nail gun tool mechanism having at least a rear end that has a plurality of mounting screws thereon;
a tool engaging plate having a plurality of apertures aligned with the mounting screws of the nail gun tool mechanism;
an upward extension section attached at one end to, and extending outwardly from, the tool engaging plate;
a forward extension section attached at one end to, and extending angularly away from, a second end of the extension section; and
a hook section attached at one end to and extending angularly away from a second end of the forward extension section;
whereby with the tool engaging plate attached to the rear end of the nail gun tool mechanism with the mounting screws, the upward extension section, forward extension section, and hook section projecting upwardly and forwardly from the rear of the nail gun tool mechanism, the hook section may engage the object to suspend the tool therefrom.

8. The tool hanging bracket of claim 7 wherein the tool engaging plate further includes a cut-out aperture for receiving a mechanism projection of the tool.

9. The tool hanging bracket of claim 7 wherein the hook section is split into two points at a second end thereof, the points for biting at least partially into the object to further hold the tool to the object.

10. The tool hanging bracket of claim 7 wherein the hook section extends away from the second end of the forward extension section at an angle of between 30 and 90 degrees.

11. The tool hanging bracket of claim 7 wherein the forward extension section extends away from the second end of the extension section at an angle of between 60 and 90 degrees.

12. The tool hanging bracket of claim 9 wherein the two points are adapted for biting at least partially into a standard wooden beam.
